(19) United States
(12) Patent Application Publication
(10) Pub. No.: US 2011/0234915 A1
(43) Pub. Date: Sep. 29, 2011

(54) DIGITAL BROADCAST REPRODUCER AND DIGITAL BROADCAST REPRODUCING METHOD

(75) Inventor: Osamu YAMADA, Nagoya-shi (JP)

(73) Assignee: Buffalo Inc., Nagoya-shi (JP)

(21) Appl. No.: 13/073,279

(22) Filed: Mar. 28, 2011

(30) Foreign Application Priority Data
Mar. 29, 2010 (JP) 2010-074118

(51) Int. Cl. H04N 5/50

(52) U.S. Cl. 348/731; 348/E05.097

(57) ABSTRACT

A digital broadcast reproducer includes a reproduction unit for reproducing the content of a channel of digital broadcast by using plural tuners, and a controller for controlling the plural tuners and the reproduction unit. Upon detecting the initiation of a zapping operation, the controller controls the reproduction unit in such a manner that the reproduction unit reproduces the content of a desired channel selected by one of the plural tuners and simultaneously prepares for the reproduction of the content of the next desired channel selected by the other of the plural tuners while switching between the plural tuners at a predetermined time interval.

### CROSS REFERENCE TO RELATED APPLICATION

This application is based upon and claims the benefit of priority from the prior Japanese Patent Application No. 2010-074118 filled on Mar. 29, 2010; the entire contents of which are incorporated herein by reference.

### BACKGROUND OF THE INVENTION

1. Field of the Invention

This invention relates to a digital broadcast reproducer for reproducing digital broadcast and to a digital broadcast reproducing method.

2. Description of the Related Art

A TV watcher may sometimes perform “zapping”, that is, frequently change over from channel to channel while CMs are on the screen. Terrestrial digital television broadcasting (hereinafter, referred to simply as “digital broadcasting”) has started recently, and for this reason, digital broadcast reproducers for reproducing digital broadcasts are becoming widely used.

The digital broadcasting is known to require longer time for switching between channels than that in analog broadcasting due to MPEG decoding and the like. Generally, a no-image/no-sound state continues for about 3 to 5 seconds after each channel switching operation by the user until the image and sound of the desired channel are outputted.

Techniques have been proposed that aim to solve such a problem by using plural tuners (see Japanese Patent Application Publication No. 2003-87668 (hereinafter, referred to as Patent Document 1) and Japanese Patent Application Publication No. 2006-191267 (hereinafter, referred to as Patent Document 2)). In the techniques disclosed in Patent Documents 1 and 2, a sub tuner constantly switches over from one channel to another and stores digital broadcast video data of the channels while a main tuner is being used to output digital broadcast video and audio data.

When the user switches a channel, the video data of the desired channel stored in the sub tuner is outputted until the main tuner starts outputting the video and audio data of the desired channel. Thus, a channel can be switched without no-image state.

Despite this, the techniques disclosed in Patent Documents 1 and 2 have the following problems.

First of all, the digital broadcast reproducer consumes a large amount of power and uses wide memory areas because the sub tuner must constantly switch over from one channel to another and store the digital broadcast video data.

Secondly, the video data stored in the sub tuner are older than currently broadcasted video data. For example, when the sub tuner stores video data for 10 channels with a time interval of 10 seconds, the oldest video data lag by 100 seconds behind the currently broadcasted video data and thus largely differs from the newest broadcasted video data. Resulting images may not be beneficial for the user.

### SUMMARY OF THE INVENTION

The object of this invention is to provide a digital broadcast reproducer and a digital broadcast reproducing method, which consume less power, use smaller memory area and have a high usability in zapping.

In order to solve the problems mentioned above, this invention has the following features.

According to one of the features of this invention, there is provided a digital broadcast reproducer comprising: a reproduction unit (reproduction unit 120) for reproducing the contents of the channels of digital broadcast by using plural tuners (first tuner 110a, second tuner 110b); and a controller (controller 130) for controlling the plural tuners and the reproduction unit, wherein
upon detecting the initiation of a zapping operation, the controller controls the reproduction unit in such a manner that the reproduction unit reproduces the content of a desired channel selected by one of the plural tuners and simultaneously prepares for the reproduction of the content of the next desired channel selected by the other of the plural tuners, while switching between the plural tuners at a predetermined time interval.

With such a feature, the plural tuners need not be operated simultaneously until the initiation of zapping is detected. Thus, the amount of power consumed and the memory area used, by the digital broadcast reproducer can be reduced as compared with those associated with the techniques disclosed in Patent Documents 1 and 2.

Moreover, simultaneously with the reproduction of the content of a desired channel, the reproduction of the content of the next desired channel is prepared. Thus, the latest content (i.e. the currently broadcasted content,) of the next desired channel can be immediately reproduced and outputted by switching to the next desired channel.

Accordingly, the digital broadcast reproducer which consumes less power, uses smaller memory area and has a high usability in zapping can be provided.

According to another feature of a digital broadcast reproducer of this invention, the controller detects the initiation of the zapping operation in accordance with a user operation instructing the initiation of the zapping operation.

With such a feature, the automatic zapping according to the above feature can be initiated as the user requires. Thus, usability in zapping can be improved.

According to another feature of a digital broadcast reproducer of this invention, the controller detects the initiation of the zapping operation when a user operation instructing to sequentially switch over the channels in ascending or descending order continues for a predetermined period of time.

With such a feature, automatic zapping can be initiated whenever the automatic zapping according to the above feature is considered effective. Thus, usability in zapping can be improved.

According to another feature of a digital broadcast reproducer of this invention, the controller detects the initiation of the zapping operation when the user switches over the channels a predetermined number of times within a unit time.

With such a feature, automatic zapping can be initiated when the user is supposed to be performing zapping. Thus, usability can be improved.

According to another feature of a digital broadcast reproducer of this invention, the controller detects the termination of the zapping operation in accordance with a user operation instructing the termination of the zapping operation.

With such a feature, the automatic zapping according to the above feature can be terminated as the user requires. Thus, usability can be improved.

According to another feature of this invention, there is provided a digital broadcast reproducer further comprising a storage unit that stores therein a candidate list that lists candidates for desired channels, wherein the controller sequentially switches over from one desired channel to another in the candidate list.

With such a feature, the range of the channels on which the automatic zapping according to the above feature is performed can be limited. Thus, channels whose contents are not watched so often can be excluded from the automatic zapping, whereby usability can be improved.

According to another feature of a digital broadcast reproducer of this invention, the candidates for desired channels are ordered in the candidate list, and the controller switches over from one desired channel to another in the order according to the candidate list.

With such a feature, the order of the channels on which the automatic zapping according to the above feature is performed can be determined. Thus, the user can swiftly find the channel whose content he or she wants to watch, whereby usability can be improved.

According to another feature of a digital broadcast reproducer of this invention, the candidate list is created or updated based on user setting, past channel selection history, or program information externally provided.

With such a feature, the order and range of channels to be automatically zapped can be determined automatically or as the user requires. Thus, usability can be improved.

According to a still another feature of this invention, there is provided a digital broadcast reproducing method for reproducing the contents of channels of digital broadcast by using plural tuners, comprising: the step of sequentially switching over desired channels at a predetermined time interval through the switching over the plural tuners upon detecting the initiation of a zapping operation, and the step of preparing for the selection of a next desired channel while selecting the currently selected channel.

### BRIEF DESCRIPTION OF THE DRAWINGS

FIG. 1 is a block diagram showing the configuration of a digital tuner device as a first embodiment of this invention;

FIG. 2 is a time chart showing an outline of an automatic zapping according to the first embodiment of this invention;

FIG. 3 is the flowchart of a process of ascending zapping according to the first embodiment of this invention;

FIG. 4 is the flowchart of a process of descending zapping according to the first embodiment of this invention;

FIG. 5 shows a candidate list according to a second embodiment of this invention;

FIG. 6 is a block diagram showing the configuration of a digital tuner device as a second embodiment of this invention;

FIG. 7 is the flowchart of a process of an automatic zapping according to the second embodiment of this invention;

FIG. 8 is a front view of a digital-broadcasting-compatible television set according to a third embodiment of this invention; and

FIG. 9 is a front view of a PC according to a fourth embodiment of this invention.

### DESCRIPTION OF THE EMBODIMENTS

First to fourth embodiments and the other embodiments of this invention are described with reference to the attached drawings. Throughout the drawings, the same or similar components are labeled with the same or similar reference numerals.

### (1) First Embodiment

In the first embodiment, a digital broadcast reproducer according to this invention is described as applied to a digital tuner device.

### (1. 1) Configuration of Digital Tuner Device

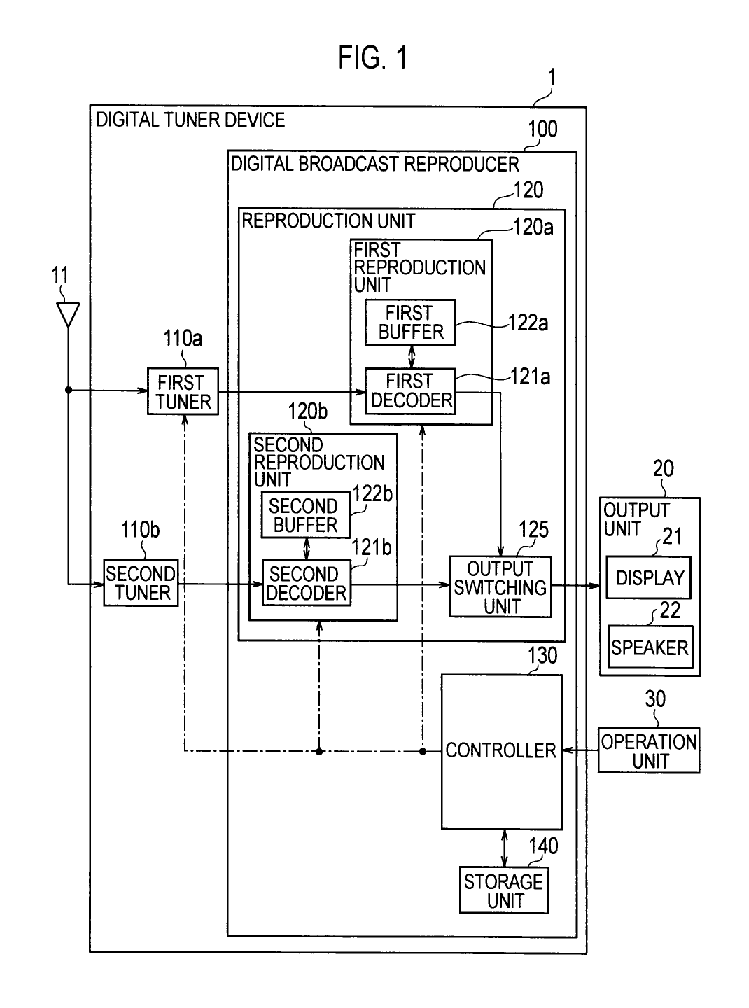

FIG. 1 is a block diagram showing the configuration of a digital tuner device according to the first embodiment. The digital tuner device 1 receives and reproduces digital broadcasts.

As shown in FIG. 1, the digital tuner device 1 is provided between an antenna 11 and an output unit 20. The digital tuner device 1 includes a first tuner 110a to which the output of the antenna 11 is fed, a second tuner 110b to which the output of the antenna 11 is fed, a first reproduction unit 120a to which the output of the first tuner 110a is fed, a second reproduction unit 120b to which the output of the second tuner 110b is fed, an output switching unit 125 to which the respective outputs of the first reproduction unit 120a and the second reproduction unit 120b are fed, a controller 130 that controls the first tuner 110a, the second tuner 110b, the first reproduction unit 120a, the second reproduction unit 120b, and the output switching unit 125, and a storage unit 140 that receives information from and transmits information to the controller 130.

A reproduction unit 120 (the first reproduction unit 120a and the second reproduction unit 120b), the output switching unit 125, the controller 130, and the storage unit 140 constitute a digital broadcast reproducer 100 for reproducing digital broadcasts.

The first tuner 110a selects one of the digital broadcast signals received by the antenna 11. The signal thus selected is amplified, down-converted, demodulated and finally outputted. The first tuner 110a tunes to the channel to be selected in response to a control signal from the controller 130. The second tuner 110b selects another one of the digital broadcast signals received by the antenna 11. The signal thus selected is amplified, down-converted, demodulated and finally outputted. The second tuner 110b tunes to the channel to be selected in response to the control signal from the controller 130. Only one of the first tuner 110a and the second tuner 110b operates during the normal television watching.

The first reproduction unit 120a reproduces the data on the channel tuned to by the first tuner 110a. To put it concretely, the first reproduction unit 120a includes a first decoder 121a for decoding the data on the tuned channel in accordance with the MPEG method and a first buffer 122a used for the decoding process by the first decoder 121a. The first decoder 121a separates the video and audio data from the MPEG2-TS signal obtained by the first tuner 110a and decodes the video and audio data.

Here, the first decoder 121a decodes the video data by using the I picture containing the entire information for a single frame, and the P and B pictures representing the information on the difference between frames.

Therefore, the video data can be decoded only after the I picture has been acquired. Thus, the decoder 121a temporarily stores the video data in the first buffer 122a first and then decodes the video data. Under the control of the controller 130, the first decoder 121a gets ready for decoding (i.e. buffering process), and initiates/terminates the decoding.

The second reproduction unit 120b reproduces the data on the channel tuned to by the second tuner 110b. To put it concretely, the second reproduction unit 120b includes a second decoder 121b for decoding the data on the tuned channel in accordance with the MPEG method and a second buffer 122b used for the decoding process by the second decoder 121b. The second decoder 121b separates the video and audio data from the MPEG2-TS signal obtained by the second tuner 110b and decodes the video and audio data. Here, the second decoder 121b temporarily stores the video data in the second buffer 122b first and then decodes the video data. Under the control of the controller 130, the second decoder 121b gets ready for decoding (i.e. buffering process) and initiates/terminates the decoding.

Under the control of the controller 130, the output switching unit 125 switches over between those signals to be delivered to the output unit 20 which are the video/audio data decoded by the first and second decoders 121a and 121b.

The output unit 20 includes a display 21 for displaying images upon receiving the decoded video data and a speaker 22 that outputs sounds upon receiving the decoded audio data.

The controller 130 performs various controls in accordance with the input from an operation unit 30 (e.g. remote controller) on which the user performs a user operation. The controller 130 monitors the operation performed on the operation unit 30 to detect the initiation and the termination of zapping. Upon detecting the initiation of the zapping, the controller 130 shifts to “automatic zapping” for automatically performing zapping.

In the first embodiment, the controller 130 detects the initiation and the termination of zapping in the following two procedures. In the first procedure where the operation unit 30 is provided with a button for initiating and terminating automatic zapping, the controller 130 detects the initiation/termination of zapping when the button is pressed. In the second procedure where the operation unit 30 is provided with a button (channel UP/DOWN button) for selecting channels sequentially in ascending or descending order, the controller 130 detects the initiation of zapping when the button is kept pressed for a predetermined period of time.

### (1. 2) Automatic Zapping

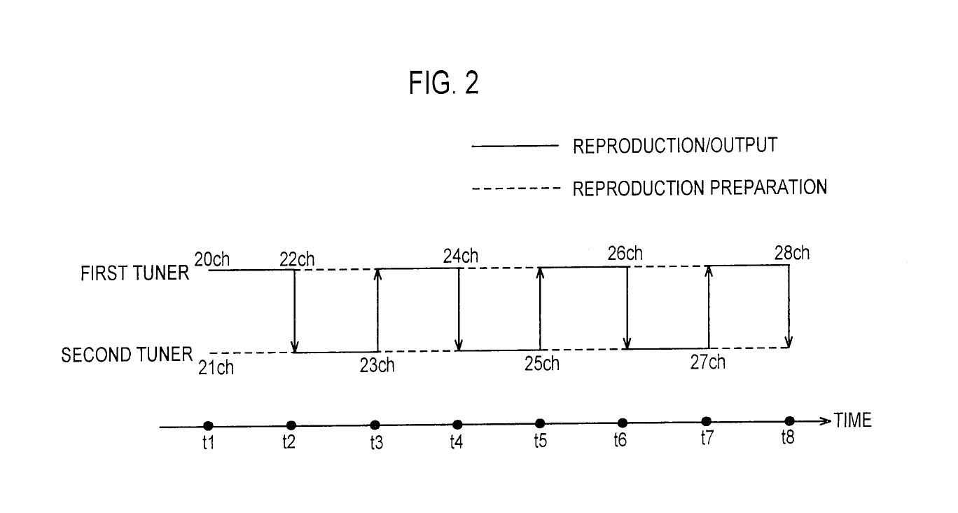

Automatic zapping is described below with reference to FIGS. 2 to 4.

### (1. 2. 1) Outline of Automatic Zapping

FIG. 2 is a time chart showing the outline of automatic zapping. Zapping, i.e. changing channels, in ascending (UP) order is explained in FIG. 2.

Let it be assumed that transition to automatic zapping took place at time t1 while Channel 20 is being watched. At this time, the first tuner 110a is tuned to the channel 20, the first reproduction unit 120a decodes the video and audio data of the channel 20, and the output switching unit 125 selects the first reproduction unit 120a. At e time t1, under the control of the controller 130, the second tuner 110b is tuned to the next channel 21 and the second reproduction unit 120b gets ready for decoding (buffering) the video and audio data of the channel 21.

At time t2, under the control of the controller 130, the second reproduction unit 120b decodes the video and audio data of the channel 21 and the output switch unit 125 selects the second reproduction unit 120b. Thus, the channel 20 being selected currently is switched to the channel 21 immediately.

At time t2, under the control of the controller 130, the first tuner 110a is tuned to the next channel 22 and the first reproduction unit 120a gets ready for decoding (buffering) the video and audio data of the channel 22.

At time t3, under the control of the controller 130, the first reproduction unit 120a decodes the video and audio data of the channel 22 and the output switch unit 125 selects the first reproduction unit 120a. Thus, the channel 21 being selected currently is switched to the channel 22 immediately. At time t3, under the control of the controller 130, the second tuner 110b is tuned to the next channel 23 and the second reproduction unit 120b gets ready for decoding (buffering) the video and audio data of the channel 23.

At time t4, under the control of the controller 130, the second reproduction unit 120b decodes the video and audio data of the channel 23 and the output switch unit 125 selects the second reproduction unit 120b. Thus, the channel 22 being selected currently is switched to the channel 23 immediately. At time t4, under the control of the controller 130, the first tuner 110a is tuned to the next channel 24 and the first reproduction unit 120a gets ready for decoding (buffering) the video and audio data of the channel 24.

Similar processes are repeated after time t5 until the termination of zapping is detected.

As described above, upon detecting the initiation of a zapping operation, the controller 130 changes over between the first and second tuners 110a and 110b at a predetermined time interval and controls the reproduction unit 120 in such a manner that the video and audio data of a desired channel selected by one of the first and second tuners 110a and 110b can be decoded and that the other of the first and second tuners 110a and 110b can get ready for decoding the video and audio data of the next desired channel. “Predetermined time interval” has only to be equal to a time period required for buffering and may be constant or arbitrarily set by a user operation.

### (1. 2. 2) Flow of Automatic Zapping

Process flows for automatic zapping are described below.

### (1. 2. 2. 1) Ascending Zapping

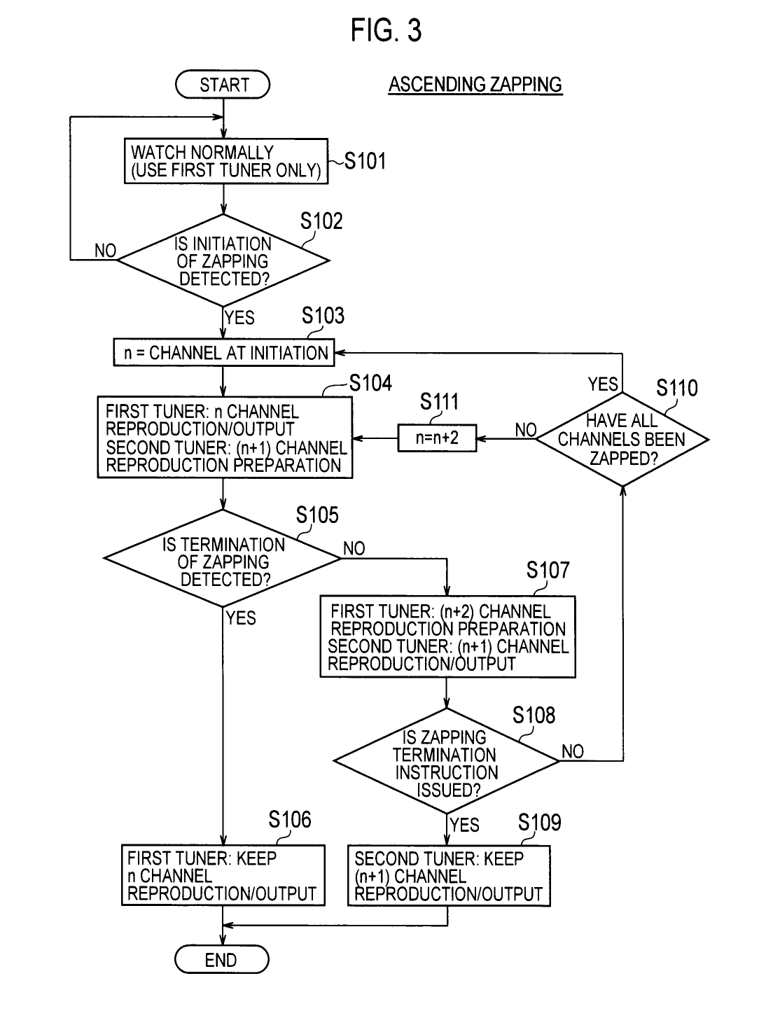

FIG. 3 is the flowchart of a process of ascending zapping.

It is assumed that in Step S101, the content of a channel is normally watched using the first tuner 110a and the first reproduction unit 120a. In Step S102, the controller 130 checks whether zapping has been initiated or not. In this flow, the controller 130 detects the initiation of zapping in ascending order when the button for instructing the automatic zapping in ascending order is pressed or the channel UP button is kept pressed for a predetermined period of time.

In Step S103, the controller 130 sets the number of channel being currently selected, as a variable n serving as a channel index.

In Step S104, the controller 130 causes the first tuner 110a to select the channel n, the first reproduction unit 120a to reproduce the content of the selected channel n, and the output switching unit 125 to deliver the reproduced output. The controller 130 also causes the second tuner 110b and the second reproduction unit 120b to get ready for the selection of the channel (n+1) and the reproduction of the content of the channel (n+1), respectively.

In Step S105, the controller 130 checks whether the ongoing zapping has terminated or not. The termination of zapping is detected, for example, when the button for instructing the termination of the automatic zapping is pressed. When detecting the termination of zapping (YES in Step S105), the controller 130 continues to cause the first tuner 110a to select the channel n, the first reproduction unit 120a to reproduce the content of the channel n, and the output switching unit 125 to deliver the reproduced output (Step S106).

If the termination of zapping is not detected, on the other hand (NO in Step 105), in Step S107, the controller 130 causes the second tuner 110b to select the channel (n+1), the second reproduction unit 120b to reproduce the content of the selected channel (n+1), and the output switching unit 125 to deliver the reproduced output. The controller 130 also causes the first tuner 110a and the first reproduction unit 120a to get ready for the selection of the channel (n+1) and the reproduction of the content of the channel (n+1), respectively.

In Step S108, the controller 130 checks whether the ongoing zapping has terminated or not. The termination of zapping is detected, for example, when the button for instructing the termination of the automatic zapping is pressed. When detecting the termination of zapping (YES in Step S108), the controller 130 continues to cause the second tuner 110b to select the channel (n+1), the second reproduction unit 120b to reproduce the content of the channel (n+1), and the output switching unit 125 to deliver the reproduced output, respectively (Step S109).

If the termination of zapping is not detected, on the other hand (NO in Step 108), the controller 130 checks in Step S110, whether all the channels have been zapped, that is, whether all the selectable channels have been scanned. Alternatively, the storage unit 140 may previously store a list of channel candidates to be subjected to zapping and it may be checked whether all the channels in the candidate list have been zapped. The candidate list can be updated, for example, by the user setting.

If all the channels have been zapped (YES in Step S110), the process returns to Step S103. If all the channels have not been zapped yet, on the other hand (NO in Step S110), the process returns to Step S104 with n reset to n+2 in Step S111.

### (1. 2. 2. 2) Descending Zapping

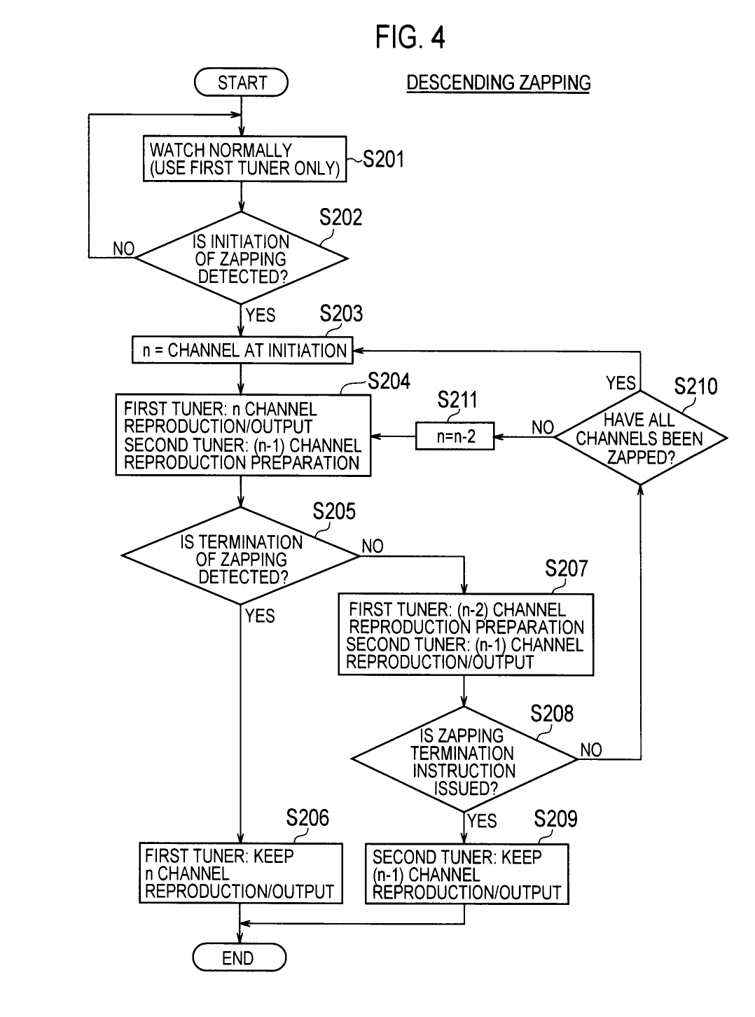

FIG. 4 is the flowchart of an automatic zapping process to switch the channels in the descending order.

It is assumed that in Step S201, the content of a channel is normally watched using the first tuner 110a and the first reproduction unit 120a.

In Step S202, the controller 130 checks whether a zapping operation has been initiated or not. In this flow, the controller 130 detects the initiation of zapping in descending order when the button for instructing automatic zapping in descending order is pressed or the channel DOWN button is kept pressed for a predetermined period of time.

In Step S203, the controller 130 sets the channel number of the currently selected channel as a variable n serving as an index of channel.

In Step S204, the controller 130 causes the first tuner 110a to select the channel n, the first reproduction unit 120a to reproduce the content of the selected channel, and the output switching unit 125 to delivber the reproduced output. The controller 130 also causes the second tuner 110b and the second reproduction unit 120b to get ready for the selection of the channel (n−1) and the reproduction of the content of the channel (n−1), respectively.

In Step S205, the controller 130 checks whether the zapping has terminated or not. The termination of the zapping is detected, for example, when the button for instructing the termination of automatic zapping is pressed. When detecting the termination of zapping (YES in Step S205), the controller 130 continues to cause the first tuner 110a to select the channel n, the first reproduction unit 120a to reproduce the content of the selected channel n, and the output switching unit 125 to deliver the reproduced output (Step S20).

If the termination of zapping is not detected, on the other hand (NO in Step 205), in Step S207, the controller 130 causes the second tuner 110b to select the channel (n−1), the second reproduction unit 120b to reproduce the content of the selected channel (n−1), and the output switching unit 125 to deliver the reproduced output. The controller 130 also causes the first tuner 110a and the first reproduction unit 120a to get ready for the selection of the channel (n−2) and the reproduction of the content of the selected channel (n−2), respectively.

In Step S208, the controller 130 checks whether zapping has terminated or not. The termination of zapping is detected, for example, when the button for instructing the termination of the automatic zapping is pressed.

When detecting the termination of zapping (YES in Step S208), the controller 130 continues to cause the second tuner 110b to select the channel (n−1), the second reproduction unit 120b to reproduce the content of the selected channel (n−1), and the output switching unit 125 to deliver the reproduced output (Step S209).

If the termination of zapping is not detected, on the other hand (NO in Step 208), the controller 130 checks in Step S210, whether all the channels have been zapped, that is, whether all the selectable channels have been scanned.

Alternatively, the storage unit 140 may previously store a list of channel candidates to be subjected to zapping and it may be checked whether all the channels in the candidate list have been zapped. The candidate list can be updated, for example, by the user setting.

If all the channels have been zapped (YES in Step S210), the process returns to Step S203. If all the channels have not been zapped yet, on the other hand (NO in Step S210), the process returns to Step S204 with n reset to n-2 in Step S211.

### (1. 3) Advantageous Effects

As described above, in the first embodiment, since the first tuner 110a and the second tuner 110b need not be operated simultaneously until the initiation of zapping is detected, then the power consumed in and the occupied memory area of, the digital tuner device 1 can be reduced. Moreover, while the content of the currently selected channel is being reproduced, the content of the next selected channel is prepared for reproduction. Thus, the most recent content (i.e. currently broadcasted content) of the next selected channel can be immediately reproduced and outputted upon switching from the currently selected channel to the next selected channel.

In the first embodiment, the controller 130 detects the initiation of zapping in accordance with the user operation instructing the initiation of zapping. Thus, the automatic zapping can be initiated as the user requires, whereby usability can be improved.

Alternatively, the controller 13 detects the initiation of zapping after the user operation for sequentially switching over channels in ascending or descending order has continued for a predetermined period of time. Thus the automatic zapping can be initiated while it is expected to be useful, whereby usability can be improved.

Moreover, the controller 130 detects the termination of zapping in accordance with the user operation instructing the termination of zapping. Thus, the automatic zapping can be terminated as the user requires. In other words, the user can check the latest contents of the channels by the automatic zapping and then watch the content of the channel he or she wants to watch, whereby usability can be improved.

### (2) Second Embodiment

In the first embodiment, the automatic zapping is performed in ascending or descending order of channel numbers. In the second embodiment, however, the automatic zapping is performed in such a manner that channels can be changed over in a controllable order.

### (2. 1) Configuration of Digital Tuner Device

For the configuration of the digital tuner device 1 of the second embodiment, the differences from the first embodiment are described.

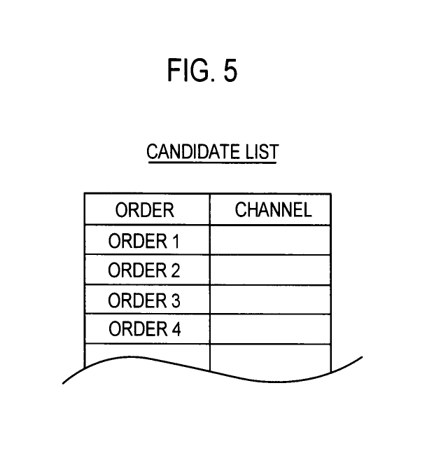

FIG. 5 shows a candidate list according to the second embodiment. As shown in FIG. 5, channels subjected to the automatic zapping (i.e. channel candidates for reproduction) are listed in the candidate list that is pre-stored in the storage 140. That is to say, the candidate list according to the second embodiment associates the order of the automatic zapping with the channels subjected to the automatic zapping. A channel located higher on the list has a higher priority.

The candidate list can be constructed and updated based on the user setting, past channel selection history, or the program information externally provided.

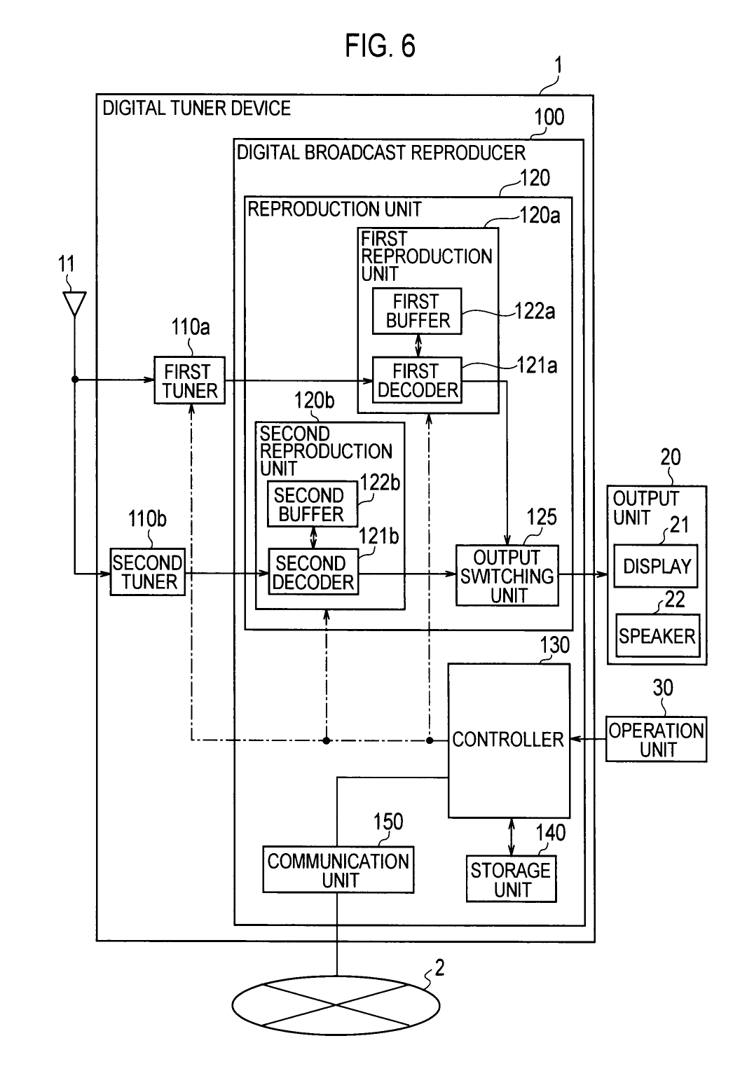

In the case of the list construction by the user, the candidate list is constructed by the user operation on the operation unit 30. Alternatively, the candidate list can be constructed through a network 2 if the digital tuner device 1 is connected to the network 2 as shown in FIG. 6. In the configuration shown in FIG. 6, the digital broadcast reproducer 100 includes a communication unit 150 for communicating through the network 2.

In the case where the list is constructed on the basis of the past channel selection history, the controller 130 causes the storage unit 140 to store the number of how many times each channel has been selected, in the storage unit 140 and periodically updates the candidate list in such a manner that the more often is selected a certain channel, in the higher position in the list it is located.

Alternatively, the controller 130 causes the storage unit 140 to store the time of how long each channel has been selected in aggregate and updates the candidate list in such a manner that the longer is the time of selection in aggregate of a certain channel, in the higher position in the list it is located.

In the case where the list construction is based on the program information externally provided, the controller 130 causes the communication unit 150 shown in FIG. 6 to obtain as the program information the information on the viewer rate ranking during the current time period and periodically updates the candidate list so as to enumerate several channels with higher viewer rates in the order of decreasing rate.

Alternatively, the categories (sports, news, variety, drama, and the like) of programs favored by the user are pre-stored in the storage unit 140; the categories of the programs corresponding to the channels selected through the network 2 or the EPG of digital broadcast are compared with the pre-stored categories; and the candidate list is periodically updated so as to contain the channels corresponding to the categories matching the categories of the programs favored by the user. The categories of the programs favored by the user may be determined on the basis of not only the user selection but also the number of viewing or the total time of viewing in the past viewing history.

### (2. 2) Detail of Automatic Zapping

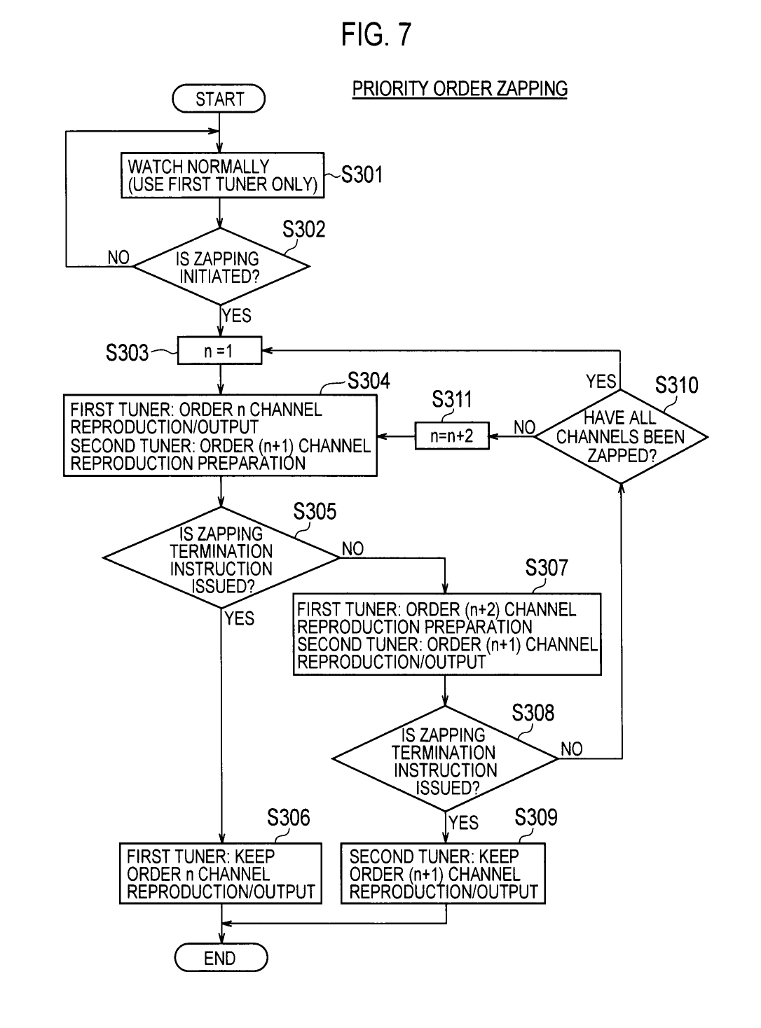

FIG. 7 is the flowchart of a process of the automatic zapping in accordance with the candidate list shown in FIG. 5.

In Step S301, the content of a channel is normally watched by using the first tuner 110a and the first reproduction unit 120a.

In Step S302, the controller 130 checks whether the zapping operation has been initiated or not. In this flow, the initiation of zapping is detected in response to the user's continuous channel switching operation. The initiation of the zapping is detected when any channel button is pressed predetermined number of times within a unit length of time.

In Step S303, the controller 130 assigns a variable n serving as the index of channel selection order to the currently selected channel.

In Step S304, the controller 130 causes the first tuner 110a to select the n-th channel, the first reproduction unit 120a to reproduce the content of the selected n-th channel, and the output switching unit 125 to deliver the reproduced output. The controller 30 also causes the second tuner 110b and the second reproduction unit 120b to get ready for the selection of the (n+1)-th channel and the reproduction of the content of the selected (n+1)-th channel, respectively.

In Step S305, the controller 130 checks whether the zapping operation has terminated or not. The termination of zapping is detected, for example, when the button for instructing the termination of the automatic zapping is pressed. When detecting the termination of zapping (YES in Step S305), the controller 130 continues to cause the first tuner 110a to select the n-th channel, the first reproduction unit 120a to reproduce the content of the selected n-th channel, and the output switching unit 125 to deliver the reproduced output (Step S306).

If the termination of the zapping is not detected, on the other hand (NO in Step 305), in Step S307, the controller 130 causes the second tuner 110b to select the (n+1)-th channel, the second reproduction unit 120b to reproduce the content of the selected (n+1)-th channel, and the output switching unit 125 to deliver the reproduced output. The controller 130 also causes the first tuner 110a and the first reproduction unit 120b to get ready for the selection of the (n+1)-th channel and the reproduction of the content of the selected (n+1)-th cnannel, respectively.

In Step S308, the controller 130 checks whether the zapping operation has terminated or not. The termination of zapping is detected, for example, when the button for instructing the termination of the automatic zapping is pressed. When detecting the termination of zapping (YES in Step S308), the controller 130 continues to cause the second tuner 110b to select the (n+1)-th channel, the second reproducing unit 120b to reproduce the content of the selected (n+1)-th channel, and the output switching unit 125 to deliver the reproduced output (Step S309).

If the termination of zapping is not detected, on the other hand (NO in Step 308), the controller 130 checks in Step S310, whether all the channels in the candidate list have been zapped. In other words, the controller 130 checks whether the zapping operation has covered all the channels in the candidate list, for example.

If all the channels in the candidate list have been zapped (YES in Step S310), the process returns to Step S303. If all the channels in the candidate list have not been zapped yet, on the other hand (NO in Step S310), the process returns to Step S304 with n re-set to n+2 in Step S311.

### (2. 3) Advantageous Effect

As described above, in the second embodiment, the order of channel selection and the range of channels to be automatically zapped can be determined. Thus, usability can be improved.

### (3) Third Embodiment

In the first and second embodiments described above, the digital broadcast reproducer 100 is used in the digital tuner device 1. In the third embodiment, however, the digital broadcast reproducer 100 is used in a digital-broadcast-compatible television set.

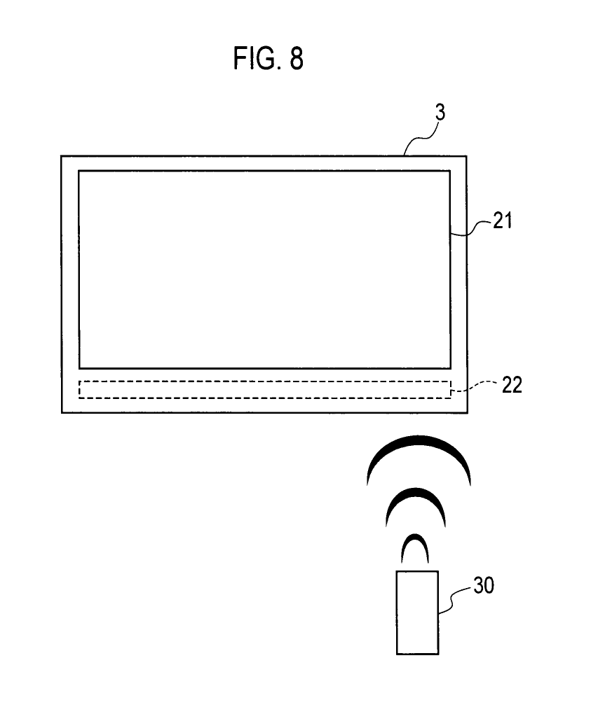

FIG. 8 is a front view of a digital-broadcast-compatible television set 3 according to the third embodiment. As shown in FIG. 8, the digital-broadcast-compatible television set 3 includes the first tuner 110a (not shown), the second tuner 110b (not shown), the digital broadcast reproducer 100 (not shown), a display 21, and a speaker 22. The digital-broadcast-compatible television set 3 is remotely controlled by an operation unit 30 (remote controller in the present embodiment).

Thus, in the third embodiment, the automatic zapping according to the first and second embodiments can be implemented in the digital-broadcasting-compatible television set 3.

### (4) Fourth Embodiment

In the first and second embodiments described above, the digital broadcast reproducer 100 is used in the digital tuner device 1. In the fourth embodiment, however, the digital broadcast reproducer 100 is described as applied to a PC.

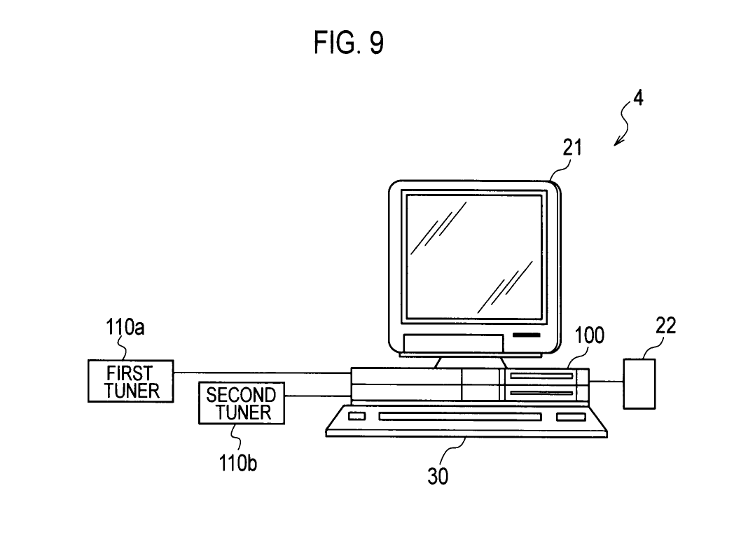

FIG. 9 is a front view of a PC 4 according to the fourth embodiment. As shown in FIG. 9, the first tuner 110a and the second tuner 110b are connected to the PC 4. The PC 4 includes the digital broadcast reproducer 100 (PC main body in this embodiment), the display 21, the speaker 22, and the operation unit 30 (key board and mouse in this embodiment). In the fourth embodiment, the various buttons described above are displayed as user interfaces (UIs) on a TV watching application.

In the PC 4, the functions of the digital broadcast reproducer 100 according to the first and second embodiments can be realized by a computer program executed by using a CPU and a memory. To put it concretely, the program causes the PC 4 to perform the step of sequentially switching between the channel whose content is to be reproduced and the tuner that selects the channel at a predetermined time interval, and the step of preparing for the reproduction of the content of the next selected channel while reproducing the content of the currently selected channel.

Thus, in the fourth embodiment, the automatic zapping according to the first and second embodiments can be implemented in the digital-broadcast-compatible television set 4.

### (5) Other Embodiments

As described above, this invention have been disclosed by using the embodiments. However, it should not be understood that the description and the drawings which constitute part of this disclosure limit the invention. From this disclosure, various alternative embodiments, examples, and operation techniques will be easily derived by those skilled in the art.

In the preceding embodiments, two tuners, i.e. the first tuner 110a and the second tuner 110b, were employed. This invention, however, may be embodied by using three or more tuners. In such a case, the automatic zapping using three or more tuners can be realized.

Alternatively, although the reproduction of the terrestrial digital TV broadcasts by the digital broadcast reproducer 100 was exemplified in the foregoing embodiments, this invention may also be embodied as means for reproducing BS digital broadcasts or 110 CS digital broadcasts.

Furthermore, the application of this invention is not limited to TV broadcasts. This invention can be applied to radio broadcasts or any broadcasting systems requiring preparation for reproduction (buffering).

The embodiments described above are not necessarily implemented independently, but can be implemented in combination.

In this manner, this invention naturally includes various embodiments not specifically described herein. Accordingly, the technical scope of the invention should be defined only by the attached claims.

What is claimed is:

1. A digital broadcast reproducer comprising:
a reproduction unit for reproducing the contents of the channels of digital broadcast by using plural tuners; and
a controller for controlling the plural tuners and the reproduction unit, wherein
upon detecting the initiation of a zapping operation, the controller controls the reproduction unit in such a manner that the reproduction unit reproduces the content of a desired channel selected by one of the plural tuners and simultaneously prepares for the reproduction of the next desired channel selected by the other of the plural tuners, while switching between the plural tuners at a predetermined time interval.

2. The digital broadcast reproducer according to claim 1, wherein the controller detects the initiation of the zapping operation in accordance with a user operation instructing the initiation of the zapping operation.

3. The digital broadcast reproducer according to claim 1, wherein the controller detects the initiation of the zapping operation when a user operation instructing to sequentially switch over the channels in ascending or descending order continues for a predetermined period of time.

4. The digital broadcast reproducer according to claim 1, wherein the controller detects the initiation of the zapping operation when the user switches over the channels a predetermined number of times within a unit time.

5. The digital broadcast reproducer according to claim 1, wherein the controller detects the termination of the zapping operation in accordance with a user operation instructing the termination of the zapping operation.

6. The digital broadcast reproducer according to claim 1 further comprising
a storage unit that stores therein a candidate list that lists candidates for desired channels, wherein
the controller sequentially switches over from one desired channel to another in the candidate list.

7. The digital broadcast reproducer according to claim 6, wherein
the candidates for desired channels are ordered in the target list, and
the controller switches over from one desired channel to another in the order according to the candidate list.

8. The digital broadcast reproducer according to claim 6, wherein the candidate list is created or updated based on user setting, past channel selection history, or program information externally provided.

9. A digital broadcast reproducing method of reproducing the contents of channels of digital broadcast by using plural tuners, comprising:
the step of sequentially switching over desired channels at a predetermined time interval through the switching over the plural tuners upon detecting the initiation of a zapping operation, and
the step of preparing for the selection of a next desired channel while selecting the currently selected channel.
